(19) United States
(12) Patent Application Publication
(10) Pub. No.: US 2008/0169132 A1
(43) Pub. Date: Jul. 17, 2008

(54) MULTIPLE STYLI ANNOTATION SYSTEM

(76) Inventors: Yao Ding, Sunnyvale, CA (US); Jacob Harel, Redwood City, CA (US); Fredrick N. Hill, Portland, OR (US); Rafael Holtzman, San Mateo, CA (US)

Correspondence Address: DOV ROSENFELD, 5507 COLLEGE AVE, SUITE 2, OAKLAND, CA, 94618, US

(21) Appl. No.: 11/968,127

(22) Filed: Dec. 31, 2007

Related U.S. Application Data
(60) Provisional application No. 60/883,248, filed on Jan. 3, 2007.

(51) Int. Cl. G06F 3/033

(52) U.S. Cl. 178/19.02

(57) ABSTRACT

A method, a software product, e.g., as logic encoded on one or more tangible media, and an apparatus for stroke capture and retrieval that works with an annotation capture and recording system that can operate with several styli active at the same time, and/or that can be formed using a plurality of panels, e.g., flat screen displays or projected displays to form a large working area.

### RELATED APPLICATION

The present invention claims benefit of and is a conversion of U.S. Provisional Patent Application No. 60/883,248 filed 3 Jan. 2007 to inventors Ding et al. The contents of such U.S. Application No. 60/883,248 are incorporated herein by reference.

### FIELD OF THE INVENTION

The present invention is related to interactive annotation systems, also called interactive whiteboards.

### BACKGROUND

Digital interactive annotation systems, also called interactive whiteboards, are becoming more and more popular in schools and corporate conference rooms. An interactive whiteboard is an electronic whiteboard writing surface—an annotation capture and recording system which can capture the position of a pointing device—an electronic stylus—electronically, and thus capture writing electronically, e.g., in group presentation situations such as teaching. By a stylus is meant such a pointing device herein. Interactive whiteboards typically but not necessarily include or are coupled to a computer. Such an interactive whiteboard is designed to allow interaction with a computer display. While interactive whiteboards are most commonly used in a classrooms, their use is increasingly seen in the workplace, e.g., in an office or on a factory floor. Such interactive whiteboards are typically used in one of three ways: 1) to capture annotations written on the whiteboard surface; 2) to control, e.g., click and drag and/or mark-up, (“annotate”) a computer-generated image displayed on or behind the touch surface; and/or 3) to operate any software that is loaded onto the connected PC, including access to the internet via a web browser.

Typical present-day interactive whiteboards only allow one stylus to operate at a time. Furthermore, the size of the working area of present-day interactive whiteboard systems is limited, e.g., to about 2.5 meters by 1.5 meters.

### BRIEF DESCRIPTION OF THE DRAWINGS

FIG. 1 shows one embodiment of a present-day interactive whiteboard system.

FIG. 2 shows one embodiment of a stylus for use in an interactive whiteboard system.

FIG. 3 shows an example embodiment of a receiver subsystem, a stylus, and a controller that in combination operate according to an embodiment of the present invention.

FIG. 4 shows a screen arrangement for an embodiment of the present invention that allows multiple styli to work simultaneously on the same working area.

FIG. 5 shows a simplified block diagram of a receiver subsystem that operated in an embodiment of the present invention.

FIG. 6 shows one version of the signaling in what is called Basic time division multiple access (TDMA) signaling herein and that is used in an embodiment of the present invention.

FIG. 7 shows one version of the signaling in what is called Offset Interleaving TDMA (OI-TDMA) signaling herein and that is used in an embodiment of the present invention.

FIG. 8 shows one version of the signaling in what is called Polling TDMA (PL-TDMA) signaling herein and that is used in an embodiment of the present invention.

FIG. 9 shows a simplified flowchart of one method embodiment of the present invention.

### DESCRIPTION OF EXAMPLE EMBODIMENTS

### Overview

Described herein is a method, a software product, e.g., as logic encoded on one or more tangible media, and an apparatus for stroke capture and retrieval that works with an annotation capture and recording system what is called an interactive whiteboard system herein—that can operate with several styli active at the same time, and/or that can be formed using a plurality of panels, e.g., flat screen displays or projected displays to form a large working area.

One embodiment includes an apparatus comprising a surface and one or more receiver subsystems each placed at a respective set of selected locations relative to the surface. The selected locations are to define a working area on the surface. Each receiver subsystem includes an electromagnetic signal sensor operative to receive electromagnet signals from one or more styli when the one or more styli are operating in the working area. Each stylus including a power source, a transmitter of ultrasound energy, at least one transmitter of electromagnetic signals, and a sensor of electromagnetic signals. Each receiver subsystem also includes an electromagnetic energy signal transmitter operative to send electromagnet signals to one or more styli when the one or more styli are operating in the working area. Each receiver subsystem also includes at least one ultrasound signal sensor operative to receive ultrasound signals from the one or more styli when the one or more styli are operating in the working area. In the case the receiver subsystem includes at least two ultrasound signal sensors and the apparatus is operative with only one receiver subsystem, two or more of the signal sensors of the receiver subsystem have a pre-defined or a determinable spatial relationship to each other. In the case each receiver subsystem includes only one ultrasound signal sensor, the apparatus includes two or more receiver subsystems whose respective ultrasound signal sensors have a pre-defined or a determinable spatial relationship to each other. The apparatus further includes at least one controller coupled to the one or more receiver subsystems and operative in combination with the one or more receiver subsystems to cause coordination of the transmitting by the styli, and operative in combination with the one or more receiver subsystems to determine the location of the one or more styli in the working area when the one or more styli are operating in the working area, such that more than one stylus can operate at the same time in the working area.

One embodiment includes a method comprising receiving electromagnet signals from one or more styli when the styli are in a working area defined on a surface. Each stylus includes a stylus tip, a power source, a transmitter of ultrasound energy, at least one transmitter of electromagnetic signals, and a receiver of electromagnetic signals. Each stylus when in a working area transmits ultrasound and communicates using electromagnetic signals. The method also includes receiving ultrasound signals transmitted from one or more styli when the styli are in the working area, the receiving being in at two or more ultrasound signal sensors, the at least two ultrasound signal sensors having a pre-defined spatial relationship to each other. The method further includes determining the location of the one or more styli in the working area when the one or more styli are operating in the working area. The transmissions of ultrasound by the one or more styli are coordinated such that more than one stylus can operate at the same time in the working area.

One embodiment includes logic encoded on one or more tangible media, the logic when executed by one or more processors operative to carry out a method comprising receiving electromagnet signals from one or more styli when the styli are in a working area defined on a surface. Each stylus includes a stylus tip, a power source, a transmitter of ultrasound energy, at least one transmitter of electromagnetic signals, and a receiver of electromagnetic signals. Each stylus when in a working area transmits ultrasound and communicates using electromagnetic signals. The method also includes receiving ultrasound signals transmitted from one or more styli when the styli are in the working area, the receiving being in at two or more ultrasound signal sensors, the at least two ultrasound signal sensors having a pre-defined spatial relationship to each other. The method further includes determining the location of the one or more styli in the working area when the one or more styli are operating in the working area. The transmissions of ultrasound by the one or more styli are coordinated such that more than one stylus can operate at the same time in the working area.

Particular embodiments may provide all, some, or none of these aspects, features, or advantages. Particular embodiments may provide one or more other aspects, features, or advantages, one or more of which may be readily apparent to a person skilled in the art from the figures, descriptions, and claims herein.

### Types of Interactive Whiteboards

Typically, an interactive whiteboard is connected to a computer using one of several possible mechanisms: via a wired connection such as USB or some other serial port cable, or wirelessly, e.g., using a standard wireless link technology such as Bluetooth. Usually, device driver software (a “whiteboard driver”) is loaded onto the attached computer. The whiteboard driver automatically starts when the computer is turned on, and the interactive whiteboard becomes active once the driver is running. The driver converts contact with the interactive whiteboard into mouse clicks or so-called “digital ink” that causes a display of annotations as a result of moving a stylus.

A present day interactive whiteboard system uses one or more of six different technologies for tracking the location of a stylus on its working area: electromagnetic (also called inductive) energy, resistive information position determining, infrared optical communication position determining, laser-based position determining, ultrasound position determining, and optical camera-based.

In a typical resistive system, two electrically conductive sheets are separated by a small layer of acetone. When a stylus touches the working area, the conductive surfaces are forced to touch at the point of contact by the surface deforming, so that an electrical contact is made. The resistance changes in the sheets establish the (X,Y) location of the touch. A typical resistive system has a soft writing surface and allows one to use a finger, a dry-erase marker, or a pointy device on the whiteboard.

A typically inductive (electromagnetic) system has an array of wires behind a board that is able to interacts with a coil in the tip of a stylus tip to determine the (X,Y) coordinate of the stylus. A stylus for operation in such a system may be active, require a battery or a wire connection to the whiteboard. Styli for inductive (electromagnetic) systems that are passive also are known, and these alter electrical signals produced by the board, but contain no power source. An inductive (electromagnetic) system typically has a hard writing surface with no moving parts. Advantages of an electromagnetic over a resistive system include increased robustness, the fact that the wrist or hand can be naturally rested on the whiteboard when writing, and a very high level of accuracy.

In a typical laser-based system, an infrared laser is located in each upper corner of the whiteboard. A laser beam sweeps across the whiteboard surface much like a lighthouse sweeps a light beam across the ocean. Reflectors on the stylus reflect the laser beam back to the source and the (X,Y) position can be triangulated. This technology typically has a hard, usually ceramic on steel surface, which has the longest life and erases most cleanly. Markers and styli are passive, but must have reflective tape to work. Touch cannot be used.

In both an optical and infrared system, when a stylus is pressed on the whiteboard surface, the stylus detects the infrared light. Software then manipulates the information to triangulate the location of the marker or stylus. This technology allows whiteboards to be made of any material.

Embodiments of the present invention operate in a system that uses ultrasound in combination with radiofrequency, e.g., infrared.

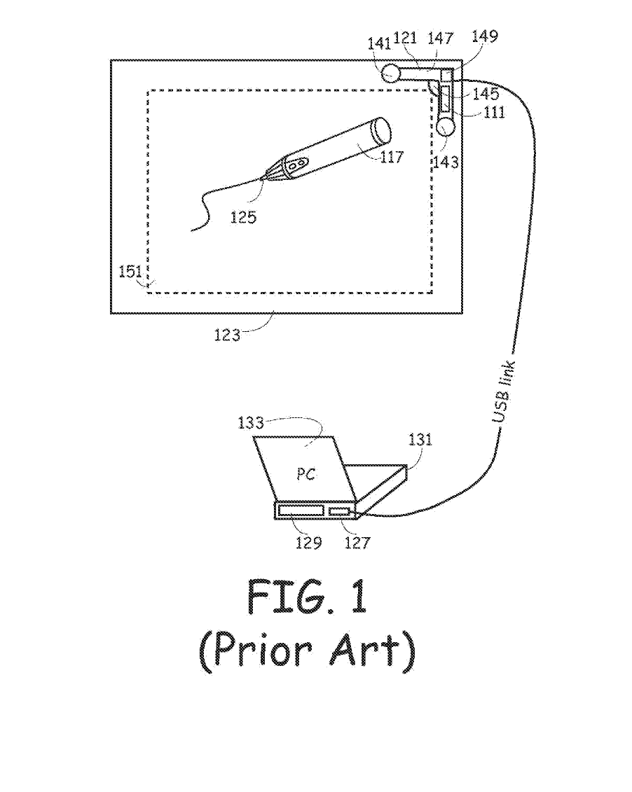

FIG. 1 shows a block diagram of an interactive whiteboard system that uses ultrasound and infrared. In this initial description of the system of FIG. 1, assume only one stylus is operative at a time. The whiteboard system includes a receiver subsystem 121 that includes a plurality of sensors and that is placed at fixed known locations at the periphery of a surface 123. The system includes an interface 149, e.g., a USB interface to interface the plurality 121 of sensors to a computer 131. The computer 131 includes a memory 129 and an interface, e.g., a USB interface 127 to accept signals from the receiver subsystems, 121, as well as a display 133.

In one embodiment, the receiver subsystem 121 includes at least two ultrasound sensors with a known spatial relationship therebetween. FIG. 1 shows the plurality 121 in the form of a receiver subsystem with two ultrasound detectors 141, 143, and one infrared sensor 145, with a mechanical member 147 establishing the spatial relationship between the sensors. The receiver subsystem forms a working area 151 on a surface, which in this embodiment is the surface 123. The system includes a controller 111 coupled to the sensors 141, 143, 145 of the receiver subsystem 121 and that includes a location determining function. This controller 111 provides in combination with the sensors, a location determining function to determine the position of a stylus 117, in particular a tip 125 of the stylus 117, in the working area 151.

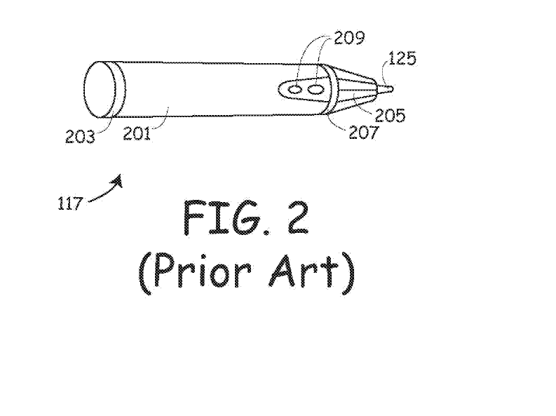

FIG. 2 shows one embodiment of the stylus 117 in more detail. In one embodiment, this is in the form of a whiteboard marker, and the tip is a marking tip. In another embodiment, meant to operate for the case of the surface 123 being a flat screen display such as an LCD or plasma display, or a projection screen, the tip need not be marked, and a display device or projector can draw any “markings” made by the tip as a result of the controller 111's location determining function determining locations of the tip as it is moved. The embodiment of FIG. 2 includes a transmitter 205 to transmit energy detectable by the receiver subsystem when the stylus is in the working area. In one version, the transmitter 205 transmits a set of ultrasound pulses detectable by the ultrasound detectors 141, 143 when the tip 125 is pressed against the surface 123, using, for example, a switch shown as switch 203 attached to the body 201 of the stylus. The stylus embodiment 117 shown in FIG. 2 also includes an infrared transmitter 207 that is operative to transmit infrared pulses detectable by the infrared sensor 145 of the receiver subsystem 121 when the tip 125 is pressed against the surface 123. The infrared pulses are synchronized with the ultrasound pulses.

In a marking version, styli such as the stylus shown in FIG. 2 are in the form of whiteboard pens, e.g., sleeves that contain the electronics, and the off-the-shelf whiteboard pens the sleeves may be fitted with. There are separate sleeves for different colors, and these send encoded data so that the location determining arrangement can determine the color of the stylus. Furthermore, each stylus has a switch that turns the stylus on or off by applying pressure on the surface. We call this stylus up and stylus down events. In a marking version, an erasing device (an eraser) also is used that has a pre-defined size, so that the location determining arrangement can know what to erase according to the location of the pre-defined size of the eraser.

One embodiment of the stylus further includes one or more buttons 209 each having a switch. When a button is depressed and the stylus is in the working area, the transmitter 205 transmits energy in a particular form related to which button was depressed. One aspect of the invention is that that the function of the buttons may be programmable, e.g., to be the left or right buttons of a mouse device. Thus, an aspect of the invention is that a button of the stylus can then provide various optional functions, in the same manner as the different buttons of a mouse or other stylus, e.g., for a computer.

The signal transmitted by the transmitter 205 of the stylus 117 may be modulated or digitally coded to identify a particular stylus function, e.g., that the stylus represents a marking device of one color or another, or that the stylus represents an eraser, or whether the stylus represents a marking device drawing a thin line or a thick line, or whether the button(s) 209 in the stylus are functionally the same as the left or right buttons of a mouse, and so forth.

One version of the stylus 117 has a low power state that hardly draws any power. Invoking any of the buttons moves the state to an active state and further provides an indication of which button was invoked. See U.S. Pat. No. 7,221,355 for details of how such a stylus operates and is constructed.

Referring again to FIG. 1, when operational, the controller 111's location determining function is able to determine the position of the stylus 117 in the working area.

The pulses transmitted by the infrared transmitter in the stylus 117 are assumed to travel much faster than the ultrasound pulses, e.g., “instantaneously.” The infrared pulses received by the infrared receiver 145 and the ultrasound pulses received by the ultrasound detectors 141, 143 are recorded in the controller 111's location determining function. In one embodiment, the operation of the controller 111's location determining function includes digitizing the signals and determining the times of arrival of the pulses. The controller 111's location determining function calculates positions of the stylus tip based on the arrival times at the two ultrasound detector positions. The time reference is generated by the infrared receiver. In one embodiment, the calculations rely on accurate recording of waveforms of the received pulses.

In different embodiments, the transmitting interface 149 of the receiver subsystem/location determining arrangement, and the matching receiving interface 127 of the PC use different communication mechanisms. In one embodiment, the receiving interface of the PC, and the matching transmitter 149 of the receiver subsystem/location determining arrangement respectively include a wireless receiver and a wireless transmitter for wireless communicating there between. One version uses Bluetooth wireless technology—also called the “Bluetooth standard” herein. Bluetooth was designed to replace cables between computing and communication devices within a 10-meter range. See www_dot_bluetooth_dot_com and www_dot_bluetooth_dot_org. Another embodiment uses wired technology, such that a wired receiver, and the matching transmitter 149 of the receiver subsystem respectively include a wired receiver and a wired transmitter for communicating therebetween using a wired connection.

Thus, in an ultrasound and infrared system, when pressed to the whiteboard surface or otherwise activated, the marker or stylus sends out both an ultrasound signal in the form of ultrasound pulses and an infrared light in the form of infrared pulses. Two ultrasound sensors—in general, transducers—receive the sound and measure the difference in the sound's arrival time, and in one version, triangulate the location of the marker or stylus.

Interactive whiteboards can have an active surface that not only captures annotations, but completely emulates the operation of software on a PC e.g., showing, pop ups, hints, hyperlinks and mouse positions so that they overcome the limitations of touch sensitive resistive boards that are limited to an on/off action. When coupled with an active board surface, whiteboard pens also offer a mouse right-click function that is so often used in digital content and programs. This means they can write like a pen and control like a mouse.

Interactive whiteboards can operate as front projection and rear projection systems when combined with a computer display. Front projection whiteboards have a video projector in front of the whiteboard. Recent innovations in short throw projection systems from the major manufacturers vastly reduce the shadow effect. Some manufacturers also provide an option to raise and lower the display to accommodate users of different heights. An active wand is also available from some manufacturers of electromagnetic boards to provide a pointing and writing device combined into one.

Rear projection whiteboard projectors are located behind the whiteboard so that no shadows occur. Rear projection whiteboards are also advantageous because the presenter does not have to look into the projector light while speaking to the audience.

One version uses LCD displays, as described herein.

### Multiple Styli

Embodiments of the present invention allow multiple styli working simultaneously on a larger size surface by scalable receiver arrays with a Time Domain Multiple Access (TDMA) signaling technique. Different embodiments use different TDMA techniques.

Assume a single stylus system can cover about 2.5 by 1.5 meters. One version covers a substantially flat surface having an area of approximately 2.5N meters by 1.5 meters, N denoting an integer (N=1, 2, 3, . . . ) and allow a number of styli to operate on the surface at the same time.

Without limiting the generality, one particular embodiment described herein allows on up to 4 styli to operate at the same time on a rectangular substantially flat surface having a diagonal of approximately 140 inches.

Embodiments of the invention described herein for operation with more than one stylus at a time include the features of the system described in FIGS. 1 and 2, including use of ultrasound pulses for position determining. The ultrasound pulses emitted by each stylus are in one embodiment at a resonant frequency of 40 kHz. In one embodiment, the pulses are transmitted by a stylus at about 70 times a second. These signaling frequencies are not limiting, and alternate embodiments use other frequencies for the ultrasound, and also other repetition rates.

One embodiment of the invention is in the form of an arrangement that includes a surface and one or more receiver subsystems each placed at a respective set of selected locations on the surface. The locations of the receiver subsystems are selected to define a suitable working area on the surface.

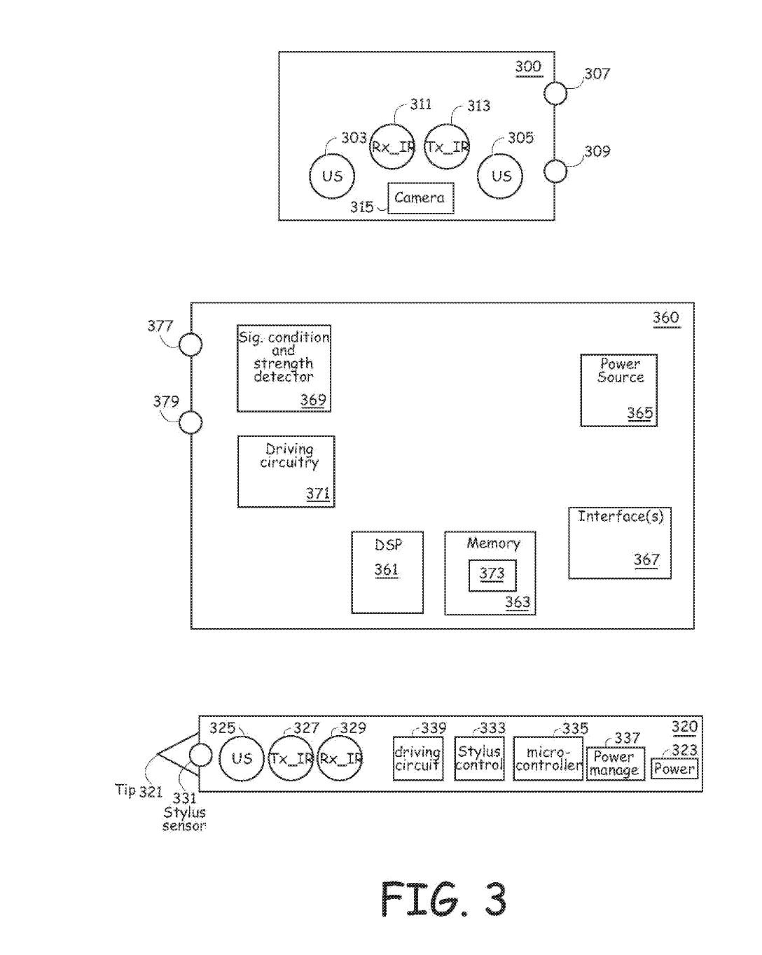

FIG. 3 shows an example receiver subsystem 300, an example controller 360, and an example stylus 320. Each such receiver subsystem 300 includes an electromagnetic signal sensor—e.g., an infrared receiver 311 with associated electronics—operative to receive electromagnet signals—e.g., infrared signals—from one or more styli when the one or more styli are operating in the working area, an electromagnetic energy signal transmitter—e.g., an infrared signal transmitter 313—operative to send electromagnet signals—e.g., infrared signals—to one or more styli when the one or more styli are operating in the working area, and at least one ultrasound signal sensor operative to receive ultrasound signals from the one or more styli when the one or more styli are operating in the working area. Two ultrasound signal sensors 303 and 305 are shown in the receive subsystem shown in FIG. 3.

In one embodiment, the ultrasound signal sensor 303 or 305 includes an ultrasonic transducer that is not only operative to receive ultrasound signals, but also operative in transmit mode to transmit ultrasound signals. The transducer operates in such a transmit mode during a calibration mode in which the receiver subsystems mutually determine their relative locations.

In one embodiment, the apparatus is operative with only a single receive subsystem. In such a case, the receive subsystem includes two ultrasound sensors 303, 305. The two ultrasound signal sensors 303, 305 of the receiver subsystem 300 have a pre-defined spatial relationship to each other, e.g., by being coupled by a mechanical link as in the system shown in FIG. 1.

In one embodiment, each receive subsystem includes only a single ultrasound sensor, and two or such receive subsystems are needed to determine the location. The respective ultrasound receivers of the two or more such receive subsystems have a determinable spatial relationship between them, e.g., determined by calibration.

Thus, in the case the receiver subsystem includes at least two ultrasound signal sensors and the apparatus is operative with only one receiver subsystem, two or more of the signal sensors of the receiver subsystem have a pre-defined or a determinable spatial relationship to each other. In the case each receiver subsystem includes only one ultrasound signal sensor, the apparatus includes two or more receiver subsystems whose respective ultrasound signal sensors have a pre-defined or a determinable spatial relationship to each other.

In FIG. 3, IR denotes infrared, and US denotes ultrasound.

Each example receiver subsystem includes at least one port to couple the receiver subsystem to a controller 360. The example receiver subsystem 300 includes two ports 307 and 309 that couple to the receiver subsystem to two controllers, such that more than one controller can operate with the same receiver subsystem. This sharing allows sharing of electronics.

One example controller 360 is shown in FIG. 3, and includes a programmable processor 361, e.g., a DSP device, a memory 363, a power source 365, an interface 367, signal receiving conditioning circuitry that includes signal strength detection circuits 369, and driving circuitry 371 for the ultrasound and electromagnetic energy signal transmitters of a receiving subsystem. The controller further includes at least one port that enables the controller 360 to be coupled to at least one receiver subsystem. In the example embodiment shown, the controller 360 includes two ports 377 and 379 such that a single controller 360 can provide control functionality for two receiver subsystem. In alternate embodiments, only each receiver subsystem has a dedicated controller. In yet another embodiment, a single controller is used for all the receiver subsystems.

FIG. 3 also shows an example stylus 320. Each stylus 320 includes a tip 321, power source 323 that includes at least one battery, at least one transmitter 325 of ultrasound energy, at least one transmitter of electromagnetic signals—e.g., infrared signal transmitter 327, and a receiver of electromagnetic signals—e.g., an infrared receiver 329 with associated electronics in the case of infrared signals. Each stylus 320 further at least one stylus sensor 331 with associated circuitry operative to detect the proximity of the stylus tip 321 to the surface. In one embodiment for operation with a rigid surface, the stylus sensor 331 includes a switch coupled to the tip 321 of the stylus so that pressing the tip 321 onto the surface causes a detection signal to be formed. In another embodiment, the stylus sensor 331 acts as a proximity detector and includes an infrared transmitter and receiver that together are operative to transmit an infrared signal and to detect the timing of any reflected signal such that detection signal to be formed when the tip is close enough to the surface. Each stylus 320 further includes stylus control circuitry 333 including stylus receiving sensor conditioning circuitry, a micro-controller system 335, power management circuitry 337, and driving circuitry 339 for the ultrasound and electromagnetic energy signal transmitters.

In one embodiment, the stylus 320 includes one or more buttons as in the stylus of FIG. 2.

The memory 363 of the controller 360 includes instructions 373 that when executed by the processor 361 carry out control functions including, when the controller is coupled to a receiver subsystem, in combination with the one or more receiver subsystems to cause coordination of the transmitting by the styli, and further, in combination with the one or more receiver subsystems to determine the location of the one or more styli in the working area when the one or more styli are operating in the working area, such that more than one stylus can operate at the same time in the working area.

The position determining includes stylus coordinate calculation. Such position determining is similar to other known method of position determining used in ultrasound and infrared whiteboard systems, and would be known to one in the art, so that the details of how to so determine coordinates is not described further herein. Those of ordinary skill in the art will be familiar with such methods. For those new to the art, see, for example, commonly owned U.S. Pat. No. 6,335,723 to Wood, et al., hereby incorporated herein by reference for how one embodiment calculates coordinates. In some embodiments of the present invention, the stylus described in U.S. Pat. No. 6,335,723 is modified so that it is a pointing device (stylus) with a non-marking tip.

In one embodiment, the coordination includes receiving information from each styli that it is in the working area, e.g., using the stylus sensor/proximity detector, and instructing each stylus to transmit infrared and ultrasound signals, including when to transmit at least the ultrasound signal, such that more than one stylus can operate at the same time.

While in one embodiment, the electromagnetic energy for communicating between the receiver subsystem(s) and the styli is in the form of infrared energy, so that each stylus includes an infrared receiver operative to receive infrared signals from one or more receiver subsystems and an infrared transmitter operative to send infrared signals to one or more receiver subsystems, in alternate embodiments, other forms of electromagnetic energy are alternately or additionally used. One embodiment uses radiofrequency signals. In yet another embodiment, optical energy in the visible wavelength range is used, alone or in combination with another form electromagnetic energy signaling.

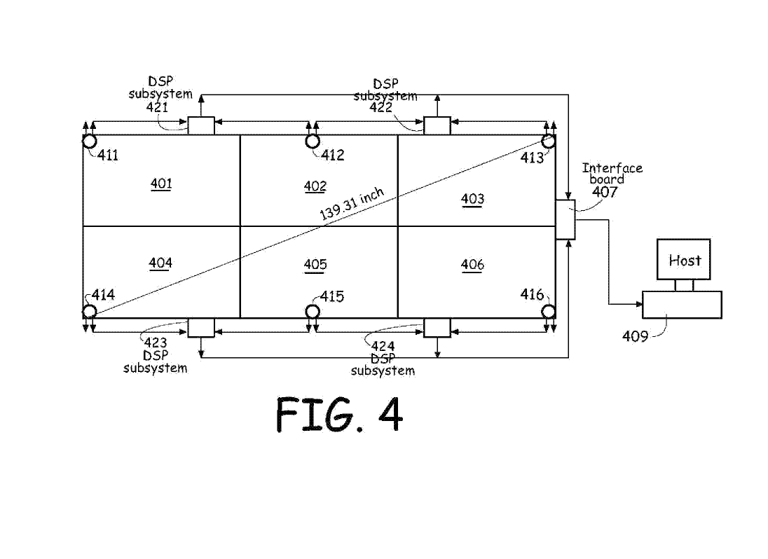

In one embodiment, the surface is a substantially planar surface made up of a plurality of flat screen displays. In one such embodiment, a plurality of receiver subsystems is used such that the working area is able to be larger than that limited by the communication range for one receiver subsystem. FIG. 4 shows an electronic whiteboard arrangement that includes an embodiment of the present inventions, and in which the surface is made up of a plurality of LCD panels that together can display a relatively large image. In this embodiment, the screen arrangement includes a 3×2 array of LCD panels constructed from 50 inch diagonal 16:9 LCD panels 401 through 406 including upper LCD panels 401-403 and lower LCD panels 404-406. To cover such a large surface, one embodiment includes six ultrasound/infrared receiver subsystems 411-416 that are each similar to the receiver subsystem 300 of FIG. 3. In the embodiment shown in FIG. 4, the controller functionality is provided by a combination of four modular subcontrollers that are in this example DSP subsystems 421 through 424, each similar to the example controller 360, and one master control and interface board 407 (“one master control and interface”) that coordinates the operation of the overall system.

In one embodiment, the three receiver subsystems 411-413 for the top LCD panels are located and aligned evenly along the top of the upper LCD panels 401-403, and the three receiver subsystems 414-416 for the lower LCD panels are aligned evenly along the bottom of the lower LCD panels 404-406, at a maximum of about 8 feet (approximately 2.5 m) apart.

On one embodiment, at least one of the ultrasound sensors of each of receiver subsystems 411-416 includes an ultrasound transducer that is operative as a receiver during normal operation as an electronic whiteboard, and that also is operative as a transmitter of ultrasound energy during a calibration mode. Each of the receiver subsystems 411-416 also includes an infrared receiver operable to receive an infrared signal that includes infrared pulses transmitted by each stylus.

In one embodiment, each of the receiver subsystems 411-416 includes two ports that can be connected to one or two of the DSP boards 421-424. Each of DSP boards 421-424 is operative to couple two respective adjacent ones of the receiver ports aligned on the top or bottom of the working surface, according to which one of the receiver subsystems is being coupled.

Each stylus is similar to the stylus 320 of FIG. 3, and is assigned a unique identifier called the stylus ID herein.

### Operation

In one embodiment, overall coordination of the whiteboard arrangement is managed by the master control and interface board 407. Each receiver subsystem if coupled to at least one DSP board, and all the DSP boards are coupled to the master control and interface board 407. In another embodiment, there is only one controller for all the receiver subsystems, and that controller includes the functionality of the master control and interface board 407.

In the following description, by a controller is meant the relevant DSP board together with the master control and interface board 407. How to design the logic circuitry, including how to program programmable elements to carry out the logic function to cause operation of the master control and interface board 407 and DSP boards would be straightforward from the functional description provided herein, so it is described herein only in such functional description in order not to obscure the inventive features. The information provided is in sufficient detail to enable one of ordinary skill in the art to design and build the apparatus, and practice the inventive method.

The master and interface board 407 is operative in one embodiment to determine the number of pens operating and to coordinate operation of the plurality of styli. In one embodiment, such coordination includes causing each receiver subsystem's infrared transmitter to broadcast a beacon signal usable by any receiving styli to time their transmission of ultrasound and infrared to allow a plurality of styli to operate at the same time. In one embodiment, such coordination includes assigning timeslots for the styli to transmit such that a plurality of styli can operate at the same time in the same working area.

When a stylus 320 initially makes contact or comes close enough with the surface, as detected by the stylus sensor/proximity detector 331 of the electronic stylus 320, the stylus sends an infrared packet to be received by the respective infrared receiver of one or more receiver subsystems to start an initial negotiation with the receiver subsystem and the controller so that the receiver subsystem and controller can sent instruction(s) to the stylus to transmit infrared and ultrasound pulses that would enable position determining. These instructions include information as to when to send the infrared and ultrasound pulses to enable more than one stylus to operate in the working area at the same time.

When the pen is removed from contact of the surface in the case of a hard, e.g., marking surface, or proximity to the surface, a pen up signal is sent by the infrared transmitter 327, and received by the respective infrared receivers of one of more receiver subsystems 411-416.

In one embodiment, the master control and interface board 407 is operative to assign for a particular stylus the receiver subsystem of receiver subsystems 411-416 responsible for the particular stylus based on the position of the particular stylus.

A particular DSP 411 in one embodiment is operative to receive a synchronization signal from the master control and interface board 407, to relay the synchronization signals to one or more styli, to accept infrared and ultrasound signals received from the particular receiver subsystem as a result of transmission by a particular stylus and to generate the stylus coordinates for a particular stylus based on the infrared and ultrasound signals received from that particular stylus.

The master control and interface board 407 is operative to receive the coordinates of the one or more styli from the individual DSP boards 421-424, and to process these to form a list of coded stylus activities. We call such processing “translating”, and these include pen-up, pen down, etc. The master control and interface board 407 serves as a single interface for all the DSP boards.

In one embodiment, the master control and interface board 407 includes at least one interface to couple the master control and interface board 407 to a host computer system 409. In one embodiment the master control and interface board 407 includes a USB interface. In another embodiment, the master control and interface board 407 includes a wireless interface, e.g., using Bluetooth. In another embodiment, the master control and interface board 407 includes a network interface, e.g., an Ethernet interface. One embodiment of the master control and interface board includes all three types of interfaces. The master control and interface board is operative to connect the whiteboard system to the host computer system 409. Yet another embodiment uses a proprietary non-standard interface.

The host system 409 can be a laptop or other computer, or a personal digital assistant, “smart” phone, a smart picture frame, a digital media player, or any system that includes a display and a processor.

In one embodiment, the host system 409 has a display interface that can drive the plurality of flat panel displays 401-406 making up the surface.

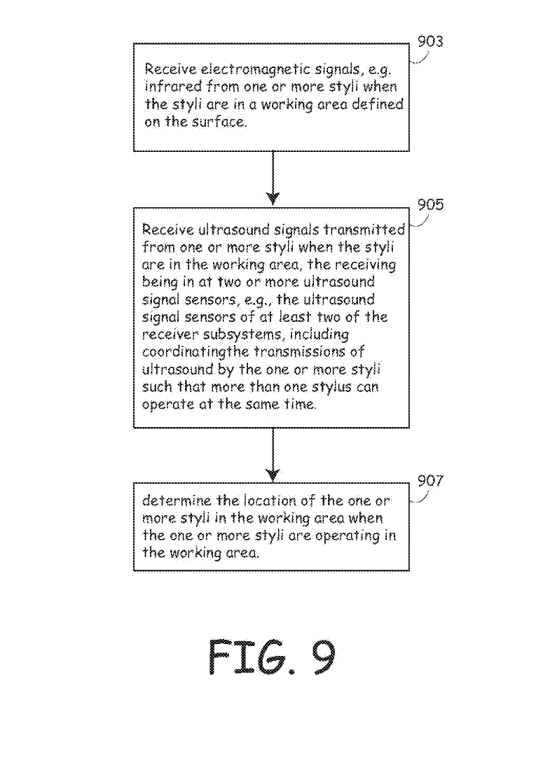

FIG. 9 shows a simplified flowchart of a method embodiment 800 of the present invention and includes in 903 receiving electromagnet signals from one or more styli when the styli are in a working area defined on a surface. Each stylus is as described above. The method also includes in 905 receiving ultrasound signals transmitted from one or more styli when the styli are in the working area, the receiving being in at two or more ultrasound signal sensors, e.g., the ultrasound signal sensors of at least two of the receiver subsystems. Thus, the at least two ultrasound signal sensors have a pre-defined spatial relationship to each other. The method further includes in 907 determining the location of the one or more styli in the working area when the one or more styli are operating in the working area. The method includes coordinating the transmissions of ultrasound by the one or more styli such that more than one stylus can operate at the same time in the working area.

One version of the method is implemented by logic encoded in tangible media of the components shown in FIG. 3 when executed by the processors shown.

### Use of an Individual Information Signal for a Particular Stylus

Consider a particular stylus. After negotiation with the particular stylus, the receiver subsystem responsible for the particular stylus is operative to send a stylus information packet to the particular stylus via the infrared link between the receiver subsystem's infrared transmitter to the particular stylus's infrared receiver to instruct the particular stylus when to start transmitting.

In one embodiment, the packet of infrared information from the receiver subsystem to the particular stylus in the form of a binary modulated infrared pulse sequence encoding a packet of information.

In one embodiment, the packet of information includes:
A stylus ID to assign to the stylus, that is the address of the stylus.
Timing information for the stylus regarding when the stylus it to start transmitting ultrasound (and infrared pulses) for position determining. In one embodiment, the timing information is provided as a delay in time units, e.g., in clock units for a clock included in the stylus from the start of packet
A packet identifier.
A CRC for error detection.

Alternate embodiments include packets that contain more or fewer items of information.

At the stylus, the particular stylus is operative to detect the start of packet, e.g., as rise in received signal strength at the stylus. The particular stylus is further operative to determine the items of information in the packet of information, and to check the CRC in order to determine if the packet was successfully received.

In the case that packet is successfully received, the stylus is operative to acknowledge successful reception. In one embodiment, successful acknowledgement is implicit by the particular stylus's transmitting infrared and ultrasound pulses at the assigned times using the respective infrared and ultrasound transmitters. The infrared pulse includes in one embodiment the stylus identifier of the particular stylus, the packet identifier to enable a received receiver subsystem/controller combination to determine which packet is being acknowledged.

One embodiment includes explicit negative acknowledgement messages (NAKs) that are transmitted using infrared by a receiving stylus that is has not correctly received the packet of information, e.g., because of an interrupted transmission, an CRC error, and so forth.

At one or more receiver subsystems, the respective infrared receiver receiving the infrared information from each stylus (including the particular stylus) and the respective DSP board, are operative to determine the start of packet of each infrared packet received at the receiver subsystem's infrared receiver, thus forming a start timing signal. Each infrared receiver also is operative to receive information packet signals such that include information such as stylus IDs, and so forth from the stylus or styli.

### Use of a Beacon Signal

While one embodiment includes use of an individual information signal for a particular stylus, in embodiment, the infrared transmitter of each one of the receiver subsystems 411-416 is operative to broadcast a beacon signal used for broadcasting synchronization signals. Each stylus is operative to receive the synchronization signals so that the styli that are operational in the working area are all synchronized. The master control and interface board 407 is operative to generate such synchronization signals and to provide them to one or more coupled DSP subsystems that in turn are coupled to the receiver subsystems.

A particular DSP board is operative to receive the synchronization signal from the master control and interface board 407, to relay the infrared broadcast signals, to accept infrared and ultrasound signals received from the particular receiver subsystem as a result of transmission by a particular stylus and to generate the stylus coordinates for a particular stylus based on the infrared and ultrasound signals received from that particular stylus.

The master control and interface board 407 is operative to receive the coordinates of the one or more styli from the individual DSP boards 421-424, and to process these to form a list of coded stylus activities. We call such processing “translating”, and these include pen-up, pen down, etc. The master control and interface board 407 serve as a single interface for all the DSP boards.

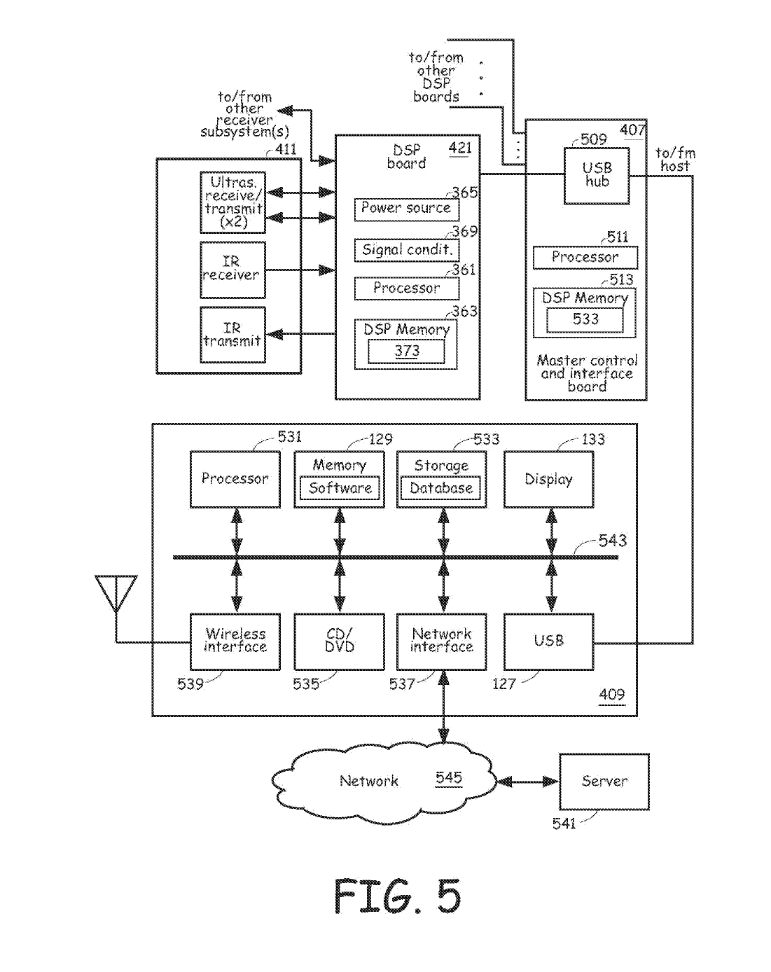

FIG. 5 shows a simplified block diagram of a receiver subsystem, e.g., 411, and also shows a host computer 407 that includes a USB communication link between a master control and interface board 407 and the DSP boards 421-424 and the receiver subsystems 411-416. In this embodiment, each receiver subsystem is as shown in FIG. 3 includes a single ultrasound sensor including the transducer with associated electronics for receiving the ultrasound signal, the infrared receiver 311 with associated electronics for receiving the infrared signal, and the infrared transmitter 313 with associated electronics for generating the infrared signal. The receiver subsystem coupled to a DSP board 421 that has the architecture shown in FIG. 3 and thus includes a processor 361 that in one embodiment is a DSP device. The ultrasound sensor of the subsystem is connected to a signal conditioner 361, e.g., a filter and amplifier. The outputs of the signal conditioner is digitized by an analog to digital converter and input via a port, e.g., a serial port of the DSP device (the processor) 361. The DSP device 361 has a DSP memory 363 coupled to processing elements of the DSP device 361, e.g., via a bus subsystem. Note that while the various processing elements, e.g., multiply-add units, general purpose logic units, and so forth, are shown as a single processor 361 in FIG. 5 and FIG. 3, those in the art will understand that this does not imply that there is only a single processing element in DSP device 361.

In this embodiment, each DSP board is coupled to two receiver subsystems whose respective ultrasound sensors are relative locations that are known or determined by calibration.

Furthermore, while embodiments of the invention use one or more DSP devices, it would be clear to those in the art that any processor or processors with sufficient processing power, e.g., one or more microprocessors or microcontrollers, may be substituted for the DSP devices, or alternately, that programmable or even hardwired logic could be used.

In one embodiment, the receiver subsystem includes some electronics. In one embodiment, the infrared sensor of the subsystem is also connected to a signal conditioner whose output is connected to an analog-to-digital converter and that further is operative to detect signal strength. A two-way switch initially connects output of the infrared signal conditioner to its analog-to-digital converter. When an infrared signal is detected, the switch connects the output of the an ultrasound signal conditioner to its analog-to-digital converter such that by the time the ultrasound signal arrives, the digitized received ultrasound pulses are input via a serial port to a DSP board.

While one embodiment of the receiver subsystem sends the digitized received ultrasound pulses together with time information and any information on the state of any buttons on the stylus to a DSP board such as board 424 for further processing, the embodiment shown in FIG. 5 includes processing at the DSP device 363 of the digitized received ultrasound pulses using time information to determine the times of arrival of the pulses relative to the times of arrival of the infrared signal. It is this information together with information on the state of any buttons on the stylus 117 that is transmitted to the DSP board 421 for further processing.

The memory 363 coupled to the DSP device 361, which may include built-in DSP memory, and more memory, e.g., additional static RAM, in one embodiment stores the program to cause the processing element(s) in DSP 363 to carry out the processing for receiving, storing, and processing the digitized coordinates, and for transmitting the results of processing to the host computer 409.

The master control and interface board 409 includes one or more interfaces, and a single interface, in the form of a USB hub interface 509, is shown herein. The master control and interface board 407 is able to be coupled to the host 409 via one or another of the included interfaces, and is shown coupled to the host computer 409 via a wired connection in FIG. 5. Wireless connection also is possible. The master control and interface board 409 includes a processor 511 and memory 513. The memory includes instructions 533 that when executed by the processor 511 carry out the master control and interface board functionality described herein.

An embodiment of the host computer 409 is shown in simplified form in FIG. 5, and includes standard components such as a processor (a CPU) 531, memory 129, storage in the form of one or more hard disks 533, an optical device 535 such as a CD-drive and/or DVD drive, a USB interface 127, a display 133, a network interface 537, and so forth. In one embodiment, the computer 547 is coupled via a network 545 to a server 541. One version, for example, includes a wireless network interface 539 for connecting to a wireless local area network to which the server 541 is connected. Elements of the computer 409 are connected via a bus subsystem 543 that, for simplicity, is shown as a simple bus in FIG. 5.

In one embodiment, the information sent to the computer is in the form of A,B un-normalized coordinates, and signals about the type of stylus, e.g., color. Calibration is separately carried out in the computer to convert the un-normalized A,B coordinates to x,y coordinates in the working area. In addition, events such as those that signal stylus up and stylus down are sent. Such events are provided as (penup, timestamp) where penup is the stylus-up event and timestamp is an indication of the time that the event occurred. A,B coordinates are provided in the form of ((A,B), pentype, any error), where the pentype indicates the color or whether the stylus is an eraser, etc. Note that in one embodiment, an eraser is regarded as a special type of stylus that erases an area around its coordinate, such that for the case of an eraser, erasure regions also are sent. Also events such as one or more buttons on the stylus being pressed are sent. Thus, the computer, after calibration, accepts a stylus down event and a stylus up event with a stream of coordinates in between that represents a contiguous line.

Assuming the maximum size of the working area for a pair of receiver subsystems is 2.5 m by 1.5 m, the worst case ultrasound time of flight, denoted T, is:

T=D/V=[(1.5̂2+2.5̂2)̂(½)]/344=8.5 ms.

In one embodiment, the location determining for a particular stylus includes determining the position using a plurality of receiver subsystems to create a redundant set positions for the stylus, such that the position can be determined from the redundancy set. This provides for error correction and fault tolerance. Furthermore, as described elsewhere, this also provides for three-dimensional rather than only two-dimensional location determining.

In one embodiment, the location determining includes identifying the direct arrival ultrasound signal for a particular stylus and separating such signal from ultrasound signals from one or more other styli. The ultrasound signal captured in a buffer via a receiver subsystem's ultrasound sensor includes signals from a particular stylus of interest and possibly one or more other signals from other, unwanted styli, such other signals having different arrival timings. One location determining method includes detecting the location of the signal of interest, and subtracting the unwanted ones. One such method embodiment includes determining the position of the wanted signal and unwanted signals from previous capture, applying a pre-selected radius to the wanted signal and unwanted signals position based on a determined speed of tracked points captured earlier, determining an updated position of wanted and unwanted signals, subtracting the unwanted signals based on the determined unwanted signal positions to create a cleaner signal, and using the cleaner signal to calculate the wanted signal position in the long ball and will more than The man who.

### Basic TDMA System

Embodiments of the invention include time domain multiple access (TDMA) signaling that allows more than one stylus to operate in the same working area.

In one embodiment each receiver subsystem broadcasts beacon signals from time to time, e.g., periodically under control of the master control and interface board. Based on time-of-flight calculation, with a longest time-of-flight of 8.5 ms, the inventors selected broadcasting every 10 ms in one embodiment. One embodiment includes assigning specific timeslots for each distinct stylus, and the broadcasts include instructions for each respective active stylus to transmit its ultrasound (and in one embodiment its infrared signals) at respective ones of their assigned timeslots. In such an embodiment, each broadcast denotes the start of a new timeslot, and includes an indication of which stylus is to transmit.

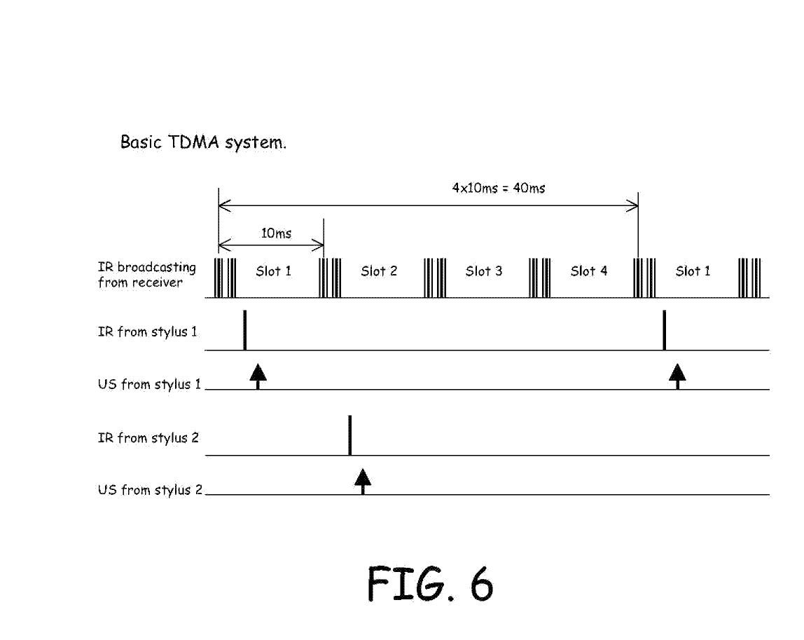

FIG. 6 shows one version of signals received at a receiver subsystem for such signaling in what is called a “Basic TDMA System” herein. The signals shown are those at a particular one of the receiver subsystems 411-416. Recall each stylus has or is assigned a unique code indicative of the stylus, e.g., a uniquely coded stylus number such as 1, 2, 3 and 4 in the case of four styli. FIG. 6 shows the signals sent and received from a receiver subsystem after a stylus is invoked, e.g., pressed against the working surface within the working area or detected to be near a surface in the case of proximity detection, the stylus is operative to sense any synchronization signals, e.g., beacons transmitted by one or more receiver subsystems under coordination of the master control and interface board 407. The synchronization packets are shown as a set of pulses in a simple representational manner for illustrative purposes only, and are not accurate depictions of infrared signals. IR denotes infrared, and US denotes ultrasound.

Suppose for this example, stylus 1 is assigned the first timeslot, and stylus 2 is assigned the second timeslot. Each of the styli transmits periodically at a period of 40 ms, that is, the number of active styli allowed for times the broadcast period.

By a frame is meant the time for all timeslots, in this case 40 ms.

The first stylus receives the broadcast beacon, identifies the synchronization signal is for itself, and acknowledges the receipt by sending an infrared pulse back to the receiver subsystem(s). After some delay sufficient to allow time for processing, the stylus send an ultrasound pulse to be detected in combination with the acknowledgment infrared pulse it sent for position determining. FIG. 6 shows two transmissions from the first stylus received at both the infrared and one of the ultrasound sensors of a receiver subsystem.

A receiver subsystem in combination with its DSP board is operative to ascertain that a stylus is operational by receiving the acknowledgment verifying such an infrared from the stylus following the synchronization packets sent by itself, and by carrying out the position determining based on the ultrasound signals arriving later to figure out the individual stylus' locations.

### Offset Interleaving TDMA (OI-TDMA)

An alternate embodiment reduces the likelihood of ultrasound interference, e.g., that an ultrasound signal sent by one leading stylus may take extra time-of-flight to arrive, e.g., by bouncing off some structures like walls, etc., and coincidentally arrive at a sensor at about the same time as ultrasound from another working stylus that has been assigned another, e.g., the next timeslot. In an alternate embodiment, the delays from receipt of the beacon synchronization to the time a stylus transmits its ultrasound are changed over time, so that such delay from one stylus to the next stylus varies according to some known time pattern from time to time.

That is, the timing between when in each successive timeslots each stylus transmits varies from frame to frame.

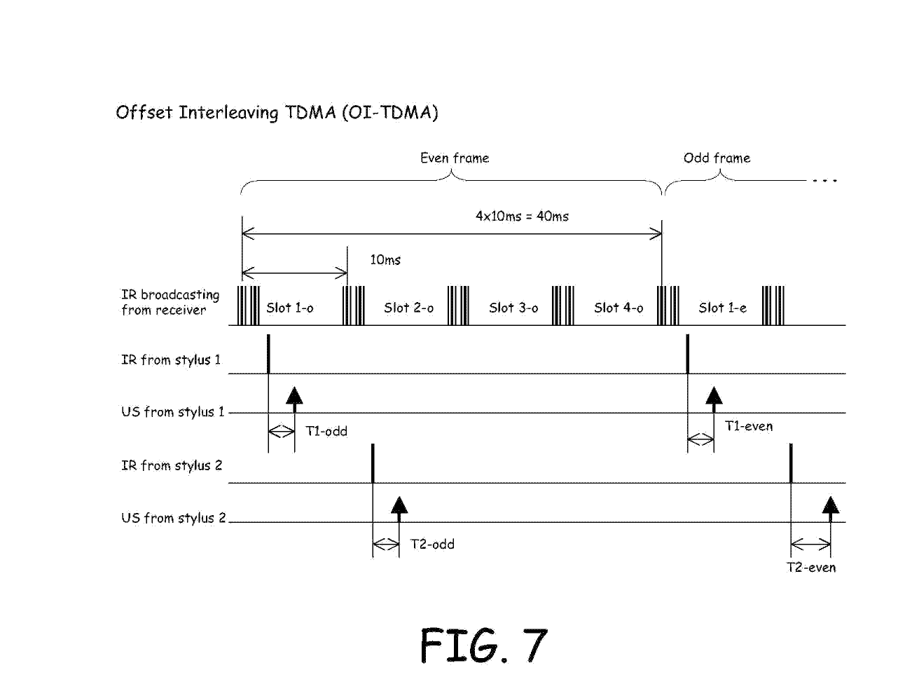

FIG. 7 shows the signaling in one such TDMA arrangement, called an “Offset Interleaving TDMA (OI-TDMA) System” herein. In one embodiment, two different types of frames are used, denoted even (“e”) frames, and odd (“o”) frames. The synchronization infrared packets sent be the receiver subsystem(s) include an identifier to provide for a receiving stylus an indication of whether to use an even or odd delay time to send its ultrasound pulse. During odd frames, odd number time slots, hence pen identifiers, have a different delay from receipt of synchronization than even numbered time slots, hence even numbered pen identifiers. A working stylus responds with a predetermined, different ultrasound timing offset, shown as Tx-odd and Tx-even, depending on whether the synchronization signal received indicates it is an odd frame time or an even frame time.

The interleaved offset effectively repositions the timing of ultrasound pulses coming from interfering styli, to reduce the chance of collisions.

Of course, different embodiments implement such a scheme in many ways. In one embodiment, the master timing and interface board is operative to cause the receiver subsystems to transmit different delays to the different styli at different frames so that subsequent frames have different times of ultrasound transmissions for different pens to reduce the likelihood of interference.

Such interleaved offset is not limited only to two types of frames. Different embodiments use a number of different frames, or frames that have different timing differences that, e.g., follow some known sequence to enable the receiver subsystems in combination with the controller to determine the position.

Such OI-TDMA methods add robustness at the cost of a more complicated stylus, which not only needs to detect the synchronization signal, but also needs to decode the frame number and timing associated with the frame.

### Polling TDMA (PL-TDMA)

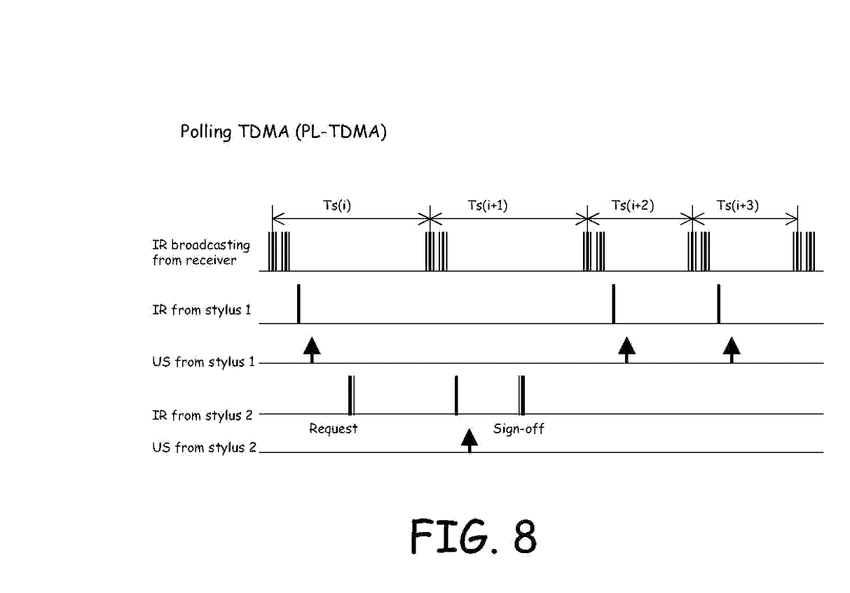

FIG. 8 shows one version of the signaling in what is called a “Polling TDMA” (“PL-TDMA”) herein. In one embodiment that uses polling TDMA, the length of a time slot is dynamically allocated based on the numbers of styli that are active at the same time in the working area.

Denote by Ts(i), i=1, 2, . . . the timeslots during which one stylus of one or more styli is active. For the purpose of illustration, assume stylus 1 is operational and active at a time denoted i, hence during a timeslot denoted Ts(i). Suppose during that time slot, stylus 2 is activated, e.g., by its stylus sensor being activated, so that stylus 2 sends an activation packet via infrared, denoted “Request” in FIG. 8, to the receiver subsystem(s), to be received by one or more receiver subsystems. Once a receiver subsystem receives the Request and the Request is properly processed, stylus 2 is added to the list of styli active and known to the controller. The controller in combination with one or more receiver subsystems polls not only stylus 1, but also stylus 2 from time to time based on a new timing scheme modified to accommodate both styli.

Some time later, suppose stylus 2 leaves the working area. This also is shown in FIG. 8. As a result, stylus 2 sends a Sign-off message via an infrared link formed between its infrared transmitter to the infrared receiver(s) in one or more receiver subsystem(s). The receiver subsystem(s) in combination with the controller are operative to remove that stylus 2 from the list of active styli. As a result, the timing is arranged so that stylus 2 is no longer being polled.

In the example of FIG. 8, stylus 1 is operational in the working area all the time, while stylus 2 just joins the list briefly by sending only one ultrasound signal.

PL-TDMA can effectively avoid ultrasound signal collision by changing the polling schedule based on the numbers of pens in use and the distance from pens to the receiver subsystems as determined by the position determining function of the receiver subsystem(s) in combination with the controller.

### Operational Modes

In one embodiment, the electronic whiteboard arrangement includes more than one mode. In location mode, the receiver subsystem(s) in combination with the controller provides the position determining function described above even for a plurality of styli operational at the same time.

In one embodiment, the ultrasound transducer in each of at least some of the receive subsystems is coupled to transmit electronics, and is operative, in what is called calibration mode herein, to transmit infrared and ultrasound such that one or more other receiver subsystems, in combination with the controller, can determine the location of the receiver subsystem that is transmitting relative to the other one or more receiver subsystems.

In such a mode, the location of one of the receiver subsystems is known, e.g., by that receiver subsystem being at a pre-defined location such as the top left hand corner of the surface. The location of other receiver subsystems is then determined during the calibration mode.

Entering calibration mode is carried out under control of the master control and interface board 407 by the master control and interface board 407 instructing the DSP boards to enter calibration mode.

Yet another embodiment includes what is called herein hovering mode in which a stylus is not active but still transmits infrared and ultrasound to be received by one or more receiver subsystems so that its location can approximately be determined. In hovering mode, the location is determined to lesser accuracy than when in active mode. This, for example, allows a curser from an application program in the host computer 409 to follow the rough location of the hovering mode stylus.

In one embodiment, the stylus sensor 331 of each stylus 320 is operational to indicate when a stylus enters hovering mode. A stylus entering hovering mode is operative to inform one or more receiver subsystems of such mode via the infrared link between its infrared transmitter to the infrared receiver(s) in one or more receiver subsystem(s). In one embodiment in hovering mode, the power consumption is reduced by adjusting how frequently a particular stylus in hovering mode transmits pulses of ultrasound signals. In another embodiment, in hovering mode, the transmit power also or alternatively is lowered.

In another embodiment, three dimensional location determining is used to determine that a stylus is entering stylus mode. In such an embodiment, one or more receiver subsystems in combination with the controller instruct the stylus to enter hovering mode, including adjusting its transmit power and/or adjusting how frequently the particular stylus in hovering mode transmits pulses of ultrasound signals.

### Power Control

One embodiment includes power control, wherein the controller in combination with the one or more receiver subsystems in communication with a particular stylus are operative to carry out power control including determining signal strength of one or both of infrared and/or ultrasound transmissions from a particular stylus, and sending control instructions to the particular stylus to adjust power and/or adjust how frequently the particular stylus to transmit pulses of ultrasound signals to reduce power consumption. This allows the styli to dynamically adjust the power needed for position determining.

Power control is desirable because, at close distance, lower ultrasound amplitude and/or lower power infrared signals provide less likelihood of non-linearity in the system due to saturation, less power consumption hence longer battery life, and lower reflected signal from surroundings, which might interfere with operation of the system.

In one embodiment, the signal strength calculation is applied to the infrared communication between a particular stylus and receiver subsystem. In one embodiment, the signal strength calculation is applied to the ultrasound from a particular stylus to a receiver subsystem. In another embodiment, the signal strength calculation is applied to both the infrared communication between a particular stylus and receiver subsystem and to the ultrasound from the particular stylus to the receiver subsystem.

The control of power uses the infrared link from a receiver subsystem to the particular stylus.

### Stylus-to-Stylus Communication

One embodiment includes stylus to stylus communication via an infrared link between the infrared transmitter of a first stylus and an infrared receiver of a second stylus. In one such embodiment, rather than the receiver subsystems being the only coordinators of messages to one or more styli of when to transmit, a first stylus can relay one or more messages from a receiver subsystem to one or more other styli including when such other styli are to transmit, e.g., according to a TDMA scheme. In one such embodiment, when it is determined that one or more styli are at locations that are problematic, e.g., from which infra red signals are not being properly received or to which signals are not being properly acknowledged, another stylus is used as a relay to such otherwise difficult to reach styli.

Consider one example of such operation. Recall that the absolute location of each stylus is known to the system, e.g., the master control and interface 407. If a receiver's signal to a particular stylus is not properly acknowledged, the master control and interface 407 is operative to determine one or more other styli that are close to the particular stylus, and to transmit a synchronization signal for the particular stylus via one or more such styli determined to be close to the particular stylus together with instruction(s) to relay the synchronization signal.

### Optical Detectors

Referring again to FIG. 3, one embodiment of the receiver subsystem 300 includes an optical sensor in the form of a camera. The receiver subsystem 300 is operable to take a camera view and to pass information to the controller, e.g., DSP board in combination with the master control and interface 407. The controller is operable to determine the number of styli in the area, e.g., by image processing. In one embodiment, the controller also is operative to determine the approximate locations of the pens using information from one or more cameras in receiver subsystems, and to assign location determining for particular pens to particular receiver subsystem. In one embodiment, the number of pens determined using information from the camera(s) is used to determine TDMA timings as described elsewhere herein.

### Non-Planar or Non-Rigid Surfaces

Note that while the drawings show a working surface that is substantially planar, the invention is not limited to such working areas. For example, a working area may be formed by a surface that is not rigid, such as a projection screen on which are projected images. One stylus for operation in such an embodiment includes a proximity sensor/proximity detector 331 that detects when the stylus is in proximity to the working surface. Alternately or in addition, the stylus includes a manual switch that can be activated by a user when the location is to be determined and/or some other function to be carried out is indicated.

As another example, a working area may be formed by a “virtual surface” in free-air that may be non-planar. One stylus for operation in such a possibly non-planar embodiment includes a manual switch that can be activated by a user when the location is to be determined.

### Three-Dimensional Detections

One embodiment includes three dimensional position determining. Such an embodiment is usable for surfaces that are three-dimensional. Determining three-dimensional location is an extension of locating two-dimensional location using triangulation of the point of transmission using ultrasound sensors at more than two ultrasound sensors whose location in three-dimensions is well known.

In one embodiment that includes a plurality of receiver subsystems, an example of which is shown in FIG. 4, each active stylus is tracked by at least two receiver subsystems. Each receiver subsystem in combination with its DSP board is operative to report a possible location of a particular transmitting stylus along a circle. Suppose two receiver subsystems in combination with their respective DSP boards track a stylus and report two respective circles. The two circles intersect at two points, one of which is in front of the surface, the other behind. The three-dimensional location is selected as the intersecting point in front of the surface.

Three dimensional location determining also provides for an alternate method of determining the proximity of the tip of a stylus to the surface. Thus, for example, in one embodiment, the determining of whether or not to enter active mode uses three dimensional position determining. In one embodiment that includes hovering mode, the determining of whether or not to enter hovering for a particular stylus includes determining the location of the particular stylus in three dimensions.

How to extend the description herein to so include three-dimensional position determining would be straightforward to one of ordinary skill in the art from the description provided herein.

Unless specifically stated otherwise, as apparent from the following discussions, it is appreciated that throughout the specification discussions utilizing terms such as “processing,” “computing,” “calculating,” “determining” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable medium that on which are encoded instructions, e.g., software that when executed by one or more processors, cause performing of one of more of the methods described herein. Note that when the method includes several elements, e.g., several steps, no ordering of such elements is implied, unless specifically stated. The instructions may reside in the hard disk, or may also reside, completely or at least partially, within the RAM and/or within the processor during execution thereof by the computer system. Thus, the memory and the processor also constitute computer-readable medium on which are encoded the instructions. Thus one embodiment is in the form of logic encoded on one or more tangible media that when executed by one or more processors is operative to carry out any of the methods described herein.

Furthermore, a computer-readable medium may form, or be included in a computer program product.

Note that while some diagram(s) only show(s) a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable on which are encoded instructions that are for execution on one or more processors, e.g., one or more processors that are part of a computer to which a stylus stroke capture system is coupled. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. Accordingly, aspects of the present invention may take the form of a method, an entirely hardware embodiment, an entirely software embodiment or an embodiment combining software and hardware aspects. Furthermore, the present invention may take the form of medium, e.g., a computer program product on a computer-readable storage medium on which are encoded instructions for a processing system.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly, it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

All publications, patents, and patent applications cited herein are hereby incorporated by reference.

Any discussion of prior art in this specification should in no way be considered an admission that such prior art is widely known, is publicly known, or forms part of the general knowledge in the field.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

Similarly, it is to be noticed that the term coupled, when used in the claims, should not be interpreted as being limitative to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

We claim:

1. An apparatus comprising:
a surface;
one or more receiver subsystems each placed at a respective set of selected locations relative to the surface, the selected locations being to define a working area on the surface, each receiver subsystem including:
an electromagnetic signal sensor operative to receive electromagnet signals from one or more styli when the one or more styli are operating in the working area, each stylus including a stylus tip, a power source, a transmitter of ultrasound energy, at least one transmitter of electromagnetic signals, and a receiver of electromagnetic signals,
an electromagnetic energy signal transmitter operative to send electromagnet signals to one or more styli when the one or more styli are operating in the working area,
at least one ultrasound signal sensor operative to receive ultrasound signals from the one or more styli when the one or more styli are operating in the working area,
wherein in the case the receiver subsystem includes at least two ultrasound signal sensors and the apparatus is operative with only one receiver subsystem, two or more of the signal sensors of the receiver subsystem have a pre-defined or a determinable spatial relationship to each other,
wherein in the case the receiver subsystem includes only one ultrasound signal sensor, the apparatus includes two or more the receiver subsystems whose respective ultrasound signal sensors have a pre-defined or a determinable spatial relationship to each other; and
at least one controller coupled to the one or more receiver subsystems and operative in combination with the one or more receiver subsystems to cause coordination of the transmitting by the styli, and operative in combination with the one or more receiver subsystems to determine the location of the one or more styli in the working area when the one or more styli are operating in the working area, such that more than one stylus can operate at the same time in the working area.

2. An apparatus as recited in claim 1, wherein the coordination includes receiving information from each stylus that is in the working area and instructing each stylus to transmit infrared and ultrasound signals, including when to transmit at least the ultrasound signal, such that more than one stylus can operate at the same time.

3. An apparatus as recited in claim 1, wherein the one or more receiver subsystems include a plurality of receiver subsystems such that the working area is able to be larger than that limited by the communication range for one receiver subsystem.

4. An apparatus as recited in claim 3, wherein the controller includes one or more modular controller subsystems, each coupled to one or more receiver subsystems.

5. An apparatus as recited in claim 3, wherein the controller further includes a master controller coupled to the one or more controller subsystems.

6. An apparatus as recited in claim 1, wherein the controller is operative to determine the number of pens operating in the working area.

7. An apparatus as recited in claim 1, wherein the coordination includes causing each receiver subsystem's electromagnetic signal transmitter to broadcast a beacon signal usable by any receiving styli to time the transmission by the receiving styli of ultrasound to allow a plurality of styli to operate at the same time.

8. An apparatus as recited in claim 1, wherein the coordination includes time domain multiple access signaling that allows more than one stylus to operate in the same working area.

9. An apparatus as recited in claim 8, wherein the coordination includes assigning specific timeslots for each distinct stylus, and instructing each respective active stylus to transmit its ultrasound signals at respective ones of their assigned timeslots.

10. An apparatus as recited in claim 8, wherein coordination is such that a delay from start of timeslot to when a stylus transmits ultrasound varies according to some known time pattern from time to time to reduce the likelihood of ultrasound interference.

11. An apparatus as recited in claim 8, wherein the coordination is such that the timing between when in each successive timeslots each stylus transmits varies from frame to frame.

12. An apparatus as recited in claim 8, wherein the coordination is such that the length of a time slot is dynamically allocated based on the numbers of styli that are active at the same time in the working area.

13. An apparatus as recited in claim 1, wherein each ultrasound sensor uses an ultrasound transducer, and wherein at least one ultrasound sensor in at least some of the receive subsystems is coupled to transmit electronics, and is operative, in a calibration mode, to transmit infrared and ultrasound such that one or more other receiver subsystems, in combination with the controller, can determine the location of the receiver subsystem that is transmitting relative to the other one or more receiver subsystems.

14. An apparatus as recited in claim 1, wherein the controller in combination with the one or more receiver subsystems in communication with a particular stylus are operative to carry out power control for the particular stylus.

15. An apparatus as recited in claim 1, wherein the controller in combination with the one or more receiver subsystems and a plurality of styli include stylus to stylus communication functionality via an electromagnetic signal link between the electromagnetic signal transmitter of a first stylus and an electromagnetic signal receiver of a second stylus.

16. An apparatus as recited in claim 15, wherein a first stylus can relay one or more messages from a receiver subsystem to one or more other styli including when such other styli are to transmit ultrasound for location determining.

17. An apparatus as recited in claim 1, wherein the one or more receiver subsystems include an optical sensor.

18. An apparatus as recited in claim 17, wherein the controller is operable to use information from one or more respective optical sensors of respective receiver subsystems to determine the number of styli in the working area.

19. An apparatus as recited in claim 1, wherein the location determining includes three dimensional position determining.

20. An apparatus as recited in claim 1, wherein the controller in combination with the one or more receiver subsystems is operative to determine whether or not a particular stylus is in a hovering mode.

21. An apparatus as recited in claim 20, wherein the location determining for a stylus in hovering mode has lower accuracy than when the stylus is active in the working area.

22. An apparatus as recited in claim 1, wherein the location determining for a particular stylus includes determining the position using a plurality of receiver subsystems to create a redundant set of positions for the stylus.

23. An apparatus as recited in claim 1, wherein location determining includes identifying a direct arrival ultrasound signal for a particular stylus and separating such direct arrival ultrasound signal from ultrasound signals from one or more other styli.

24. An apparatus as recited in claim 1, wherein a stylus further includes a stylus sensor operative to detect the proximity of the stylus tip to the surface.

25. An apparatus as recited in claim 1, wherein the electromagnetic energy signals for communicating between each receiver subsystem and the styli is in the form of infrared energy signals.

26. An apparatus as recited in claim 1, wherein the electromagnetic energy signals for communicating between each receiver subsystem and the styli is in the form of radiofrequency signals.

27. An apparatus as recited in claim 1, wherein the surface is a substantially planar surface.

28. An apparatus as recited in claim 1, wherein the surface is a non-rigid surface.

29. An apparatus as recited in claim 1, wherein the surface is a substantially planar surface made up of a plurality of flat screen displays coupled to a host computer system to which the controller is coupled.

30. An apparatus as recited in claim 1, wherein the working area follows a pre-defined three dimensional surface.

31. An apparatus as recited in claim 1, wherein at least one controllers includes a plurality of ports to which a receiving subsystem may be coupled, such that the number of the ports may exceed the number of the receiving subsystems to allow more receiving subsystem to be coupled to the controller in order to expand the maximum captured size.

32. A method comprising:
receiving electromagnet signals from one or more styli when the styli are in a working area defined on a surface, each stylus including a stylus tip, a power source, a transmitter of ultrasound energy, at least one transmitter of electromagnetic signals, and at least one receiver of electromagnetic signals, each stylus in a working area transmitting ultrasound and communicating using electromagnetic signals,
receiving ultrasound signals transmitted from one or more styli when the styli are in the working area, the receiving being in at two or more ultrasound signal sensors, the at least two ultrasound signal sensors having a pre-defined or determinable spatial relationship to each other; and
determining the location of the one or more styli in the working area when the one or more styli are operating in the working area;
wherein the transmissions of ultrasound by the one or more styli are coordinated such that more than one stylus can operate at the same time in the working area.

33. A method as recited in claim 32, wherein the coordination uses an electromagnetic energy signals.

34. A method as recited in claim 32, wherein the coordination includes receiving information from each stylus that it is in the working area, and instructing each stylus to transmit infrared and ultrasound signals, including when to transmit at least the ultrasound signal, such that more than one stylus can operate at the same time.

35. A method as recited in claim 32, wherein the coordination includes broadcasting a beacon signal usable by any receiving styli to time the transmitting by the receiving styli of ultrasound to allow a plurality of styli to operate at the same time.

36. A method as recited in claim 32, wherein the coordination includes time domain multiple access signaling that allows more than one stylus to operate in the same working area.

37. Logic encoded on one or more tangible media, the logic when executed by one or more processors operative to carry out a method comprising:
receiving electromagnet signals from one or more styli when the styli are in a working area defined on a surface, each stylus including a stylus tip, a power source, a transmitter of ultrasound energy, at least one transmitter of electromagnetic signals, and at least one receiver of electromagnetic signals, each stylus in a working area transmitting ultrasound and communicating using electromagnetic signals,
receiving ultrasound signals transmitted from one or more styli when the styli are in the working area, the receiving being in at two or more ultrasound signal sensors, the at least two ultrasound signal sensors having a pre-defined or determinable spatial relationship to each other; and
determining the location of the one or more styli in the working area when the one or more styli are operating in the working area;
wherein the transmissions of ultrasound by the one or more styli are coordinated such that more than one stylus can operate at the same time in the working area.
